(19) United States
(12) Patent Application Publication
(10) Pub. No.: US 2024/0229689 A1
(43) Pub. Date: Jul. 11, 2024

(54) CLEANING DEVICE FOR LIQUIDS, IN PARTICULAR FOR OIL-BASED LIQUIDS

(71) Applicant: SMS group GmbH, Düsseldorf (DE)

(72) Inventors: Christian MOHR, Kerpen (DE); Markus WYPADLO, Aachen (DE); Nikolai STROKOW, Mönchengladbach (DE)

(73) Assignee: SMS group GmbH, Düsseldorf (DE)

(21) Appl. No.: 18/289,509

(22) PCT Filed: Mar. 18, 2022
(86) PCT No.: PCT/EP2022/057126

§ 371 Date: Nov. 29, 2023

(30) Foreign Application Priority Data
May 7, 2021 (DE) 10 2021 204 652.5

(51) Int. Cl. F01M 1/10; F01M 11/03

(52) U.S. Cl. CPC F01M 1/10; F01M 11/03; F01M 2001/105; F01M 2011/031

(57) ABSTRACT

The invention relates to a cleaning device (10) for liquids, in particular for oil based liquids, and comprises a housing (12), which contains liquid or through which liquid flows, and at least one cleaning body (16), which is accommodated within the housing (12) and to which the liquid can be supplied, and the material of the cleaning body (16) is designed such that impurities contained in the liquid can be introduced and absorbed therein. The cleaning body (16) is attached in a cover (13) of the housing (12).

### CROSS-REFERENCE TO RELATED APPLICATION

This application is a national stage application, filed under 35 U.S.C. § 371, of International Patent Application PCT/EP2022/057126, filed on Mar. 18, 2022, which claims the benefit of German Patent Application DE 10 2021 204 652.5, filed on May 7, 2021.

### TECHNICAL FIELD

The disclosure relates to a cleaning device for liquids.

### BACKGROUND

In the operation of oil-carrying systems or machines, the aim is generally to ensure that the oil they contain is as clean as possible and free from any impurities. However, in practice, even the greatest care cannot prevent the smallest and finest dirt particles from penetrating an oil-carrying system and remaining there. Such dirt particles can consist of sands and corundums from grinding processes or from production processes of forged and cast parts, or also of many other metallic particles.

A further source of contamination is wear within oil-carrying systems. There is also a kind of self-reinforcement effect in this respect: This means that wear causes more soiling, which in turn causes more wear.

According to the prior art, a device for collecting and retaining impurities in liquids in a housing accommodating rotating machine elements is known, with which a cleaning mat, which can have a porous structure (for example, in JP 59 062 797 A1) or a fibrous structure (for example, in EP 1 091 163 A1), is attached in a base region of the housing. In any case, such a cleaning mat ensures that sinking dirt particles are permanently retained in it and thus removed from further circulation in the machine housing.

The prior art specified above has the disadvantage that inserting a cleaning mat into the housing and positioning it on a bottom surface of the housing is comparatively complex. In addition, there is the requirement that, for such an attachment of the cleaning mat to the base surface of the housing, it must be ensured that other moving parts in the housing are at a sufficient distance from the cleaning mat.

### SUMMARY

The disclosure is based on the object of simplifying the provision of a cleaning body in a housing in which liquid is held or guided by inexpensive means, while at the same time optimizing the cleaning effect.

The above object is achieved by a cleaning device as claimed.

A cleaning device is used for cleaning liquids, in particular oil-based liquids or hydraulic oils. Such cleaning device comprises a housing in which liquid is contained or through which liquid flows, and at least one cleaning body, which is accommodated within the housing and to which the liquid can be supplied, wherein the material of the cleaning body is designed such that impurities contained in the liquid can be introduced and absorbed therein. The cleaning body is attached in a cover of the housing or adjacent to it. Characteristic feature of such cleaning device are that wherein the cleaning body comprises fiber material, that the cleaning body comprises a top layer and a bottom layer, that the top layer contains fibers, which at an outer free edge of the top layer are outwardly directed with their respective free ends away from the bottom layer whereby the top layer of the cleaning body has an open surface on an outer edge into which contaminants and/or dirt particles can be introduced, and that a density of the bottom layer is greater than a density of the top layer, wherein the cleaning body is attached to the housing or a part thereof with the bottom layer, and wherein the top layer can be supplied with the liquid

The embodiment specified above is based on the essential finding that the attachment of the cleaning body in a cover of the housing or adjacent to it is possible in a simple and inexpensive manner. In addition, the cleaning body can also be attached to a cover or adjacent to it at a later point in time, specifically on machines or appliances that are already in use. Furthermore, this makes it possible for the cleaning body to be replaced with little effort after a long period of operation, if necessary, because only the cover needs to be removed from the housing.

For the purposes of the present disclosure, the feature according to which the cleaning body can be supplied with the liquid is to be understood as meaning that the cleaning body is flowed against (not: flowed through) by the liquid. In other words, when the cleaning body is “supplied” by or with, as the case may be, the liquid, the liquid flows past the cleaning body. In this respect, it should be emphasized that the flow velocity in the cleaning body, i.e., within its material structure, is always zero, even when liquid is flowing past. Taking this into account, the present disclosure ensures that dirt particles which may be contained in the liquid are caught in the material structure of the cleaning body and then remain in it permanently. Cleaning or filtering, as the case may be, liquids is based on this principle in order to remove dirt particles contained therein and bind them in the material structure of the cleaning body as explained.

A further cleaning device, which is also used for cleaning liquids, in particular oil-based liquids or hydraulic oils, and which is of independent importance, comprises a housing with an inlet opening and an outlet opening for the liquid, wherein the liquid can flow through the housing from the inlet opening to the outlet opening, and at least one cleaning body, which is accommodated within the housing and to which the liquid can be supplied, wherein the material of the cleaning body is designed such that impurities contained in the liquid can be introduced and absorbed therein. With such cleaning device, it is provided that a plurality of preferably horizontally extending levels are provided in the housing, which can be arranged in a manner parallel to one another, wherein at least one cleaning body is attached to the levels on at least one side thereof, preferably over the entire surface. Thereby, the inlet opening on one side of the housing is in a lower region and the outlet opening on an opposite side of the housing is in an upper region. Furthermore, the levels in the housing are arranged next to one another in such a manner that the liquid can flow through the housing from the inlet opening to the outlet opening in a meandering pattern. More specifically, the levels in the housing are arranged—viewed in a vertical direction—in each case one above another whereby the liquid can flow through the housing—viewed in a vertical direction—from the inlet opening to the outlet opening in a meandering pattern

With the cleaning device specified above, a plurality of cleaning bodies are in each case attached on a plurality of levels within the housing, which—viewed in the vertical direction—are arranged one above the other in each case. Thereby, such arrangement of the individual levels within the housing and the resulting flow paths for the liquid are selected in such a manner that the liquid, after entering the housing through the inlet opening, then flows through the housing in a meandering pattern in the direction of the outlet opening—viewed in a vertical direction—and is thereby guided past the cleaning bodies in each case, which are attached on the individual levels as explained. As a result, intensive cleaning of the liquid within the housing is achieved with advantageously low counter-pressure compared to flow filters, with which the flowing through the liquid is provided.

In an advantageous further development, with the embodiment specified above of the cleaning device, the levels in the housing are in each case arranged horizontally and—viewed in the vertical direction—one above the other in each case. Accordingly, the liquid that is guided through the housing can flow through the housing from the inlet opening to the outlet opening in a meandering pattern—viewed in a vertical direction. Thereby, it is useful if a cleaning body is attached on the upper side of the individual levels in each case with as large an area as possible. This makes it possible for dirt particles contained in the liquid to be deposited in the material structure of the cleaning body, also by sedimentation as a result of gravity.

In accordance with an alternative of the embodiment of the cleaning device, it can also be provided that the plurality of levels are in each case arranged vertically within the housing and are positioned next to one another when viewed over a width or length, as the case may be, of the housing. This ensures that the liquid then flows through the housing in a meandering pattern when viewed horizontally.

A further cleaning device, which is also used for cleaning liquids, in particular oil-based liquids or hydraulic oils, and which is of independent importance, comprises a housing with an inlet opening and an outlet opening for the liquid, wherein the liquid can flow through the housing from the inlet opening in the direction of the outlet opening, and at least one cleaning body, which is accommodated within the housing and to which the liquid can be supplied, wherein the material of the cleaning body is designed such that impurities contained in the liquid can be introduced and absorbed therein. A characteristic feature of such cleaning device is that the housing is designed in the form of a connecting line, wherein the cleaning body is attached within the connecting line on its inner circumferential surface, and wherein the cleaning body comprises fiber material.

With the cleaning device just mentioned, the housing is designed in the form of a connecting line. This refers to any type of housing, regardless of its material composition and shaping, by means of which the liquid is transported or guided, as the case may be, over a certain distance.

In an advantageous further development of the last-mentioned embodiment for the cleaning device, it can be provided that the cleaning body, which comprises fiber material, is attached within the connecting line along its entire longitudinal extension and/or in particular over its entire inner circumferential surface. This ensures that the liquid, while flowing through the connecting line, continuously flows past the cleaning body over as large an area as possible, in order to achieve intensive cleaning of the liquid from dirt particles or the like, as already explained elsewhere above.

In an advantageous further development, the connecting line can take the form of a flexible hose in particular. Such a hose can be made of plastic material. Alternatively, it is also possible to produce the connecting line from a metallic material with any cross-section.

The mode of operation of a cleaning device in accordance with the present disclosure and a cleaning body used for this purpose is that dirt particles contained in a liquid (in particular an oil-based liquid) sink downwards due to gravity. Thereby, if the liquid is located above the cleaning body of a cleaning device, the effect occurs that the dirt particles then enter the material structure of the cleaning body as a result of sinking downwards and then remain in it. The same effect also occurs when the liquid flows past the cleaning body, as already explained above in connection with the “supply” features.

For all of the cleaning devices specified above, it applies in the same manner that the cleaning body can consist of porous material or can comprise porous material. Additionally or alternatively, it can be provided that the cleaning body contains fibrous material—in this case, it is expedient for the cleaning body to be in the form of a cleaning mat with a fibrous texture.

In an advantageous further development, the cleaning body (or the cleaning mat, as the case may be) can have at least a bottom layer and a top layer, the density of the bottom layer being greater than the density of the top layer. In this case, the bottom layer of the cleaning body is attached to the housing or a part of it. As a result, the upper layer of the cleaning body (or the cleaning mat, as the case may be) is then supplied with the liquid, causing the liquid to flow past the upper layer.

The configuration of the cleaning body specified above with a top layer (with lower density) and a bottom layer (with higher density) has the advantage that dirt particles contained in the liquid can initially penetrate or enter, as the case may be, the top layer more easily and then, when they “migrate” in the direction of the bottom layer, are retained there (i.e., in the region of the bottom layer), because here the velocity of the liquid is zero or reduced to zero, as the case may be. As a result, a good cleaning intensity is achieved with simple and inexpensive means.

With respect to the configuration of the cleaning body, it should be pointed out at this point that its fiber structure can also be designed in such a manner that the density decreases in the direction of the bottom layer. In any case, even with such a configuration of the cleaning body, a permanent retention or remaining, as the case may be, of dirt particles within the cleaning body or its fiber structure, as the case may be, is ensured by the fact that the velocity of a liquid flowing past the cleaning body is reduced within the cleaning body and, in particular, is reduced to zero in the region of the bottom layer or adjacent thereto. With such a variant of the cleaning body, it can be advantageous that the fiber structure has relatively long fibers.

Furthermore, the present disclosure provides for a hydraulic line through which a liquid, in particular an oil-based liquid or a hydraulic oil, can flow. In this case, it is expedient that at least one of the cleaning devices specified above is incorporated or integrated, as the case may be, in such hydraulic line. In the same manner, at least one of the cleaning devices specified above can also be incorporated or integrated, as the case may be, into a hydraulic circuit for a machine in which a liquid, in particular in the form of an oil-based liquid or a hydraulic oil, is circulated.

Further advantages that can be achieved with the present invention consist of the following aspects or features, as the case may be:
Operation of a machine with “thinner oil” (i.e., a lower viscosity): This results in lower resistance or energy consumption, as the case may be, with the same or even longer service life.
Bearings of machine elements or the like can be dimensioned smaller, with the following advantages: less moving masses; smaller overall sizes; savings with respect to production and operating costs.
Filtering of a liquid with respect to dirt particles of all possible sizes, for example with a size of only a few μm as well. This achieves a very high degree of purity for the liquid (for example, oil-based liquid or hydraulic oil), also combined with the advantage that a flow of the liquid past the cleaning body does not cause a pressure drop (or counter-pressure, as the case may be).
Low production costs if, for example, the cleaning body consists of a cleaning mat (either flat or round shaping) with a fibrous texture.
Examples of embodiments of the invention are described in detail below with reference to a schematically simplified drawing.

### BRIEF DESCRIPTION OF THE DRAWINGS

FIG. 1 shows a cross-sectional view of a cleaning device in accordance with a first embodiment,

FIG. 2 shows a cross-sectional view of a cleaning device in accordance with a second embodiment,

FIG. 3 shows a cross-sectional view of a cleaning device in accordance with a third embodiment,

FIG. 4 shows a cross-sectional view of a cleaning device in accordance with a fourth embodiment,

FIG. 5 shows a cross-sectional view of a cleaning device in accordance with a fifth embodiment,

FIG. 6 shows a cross-sectional view of a cleaning device in accordance with a sixth embodiment,

FIG. 7a shows a cross-sectional view of a cleaning device in accordance with a seventh embodiment,

FIG. 7b shows a perspective view, in half section, of the cleaning device as in FIG. 7a,

FIG. 8a shows a top view of a plate with recesses, which is used in the embodiment of FIG. 7a or FIG. 7b, as the case may be,

FIG. 8b shows a cross-sectional view through the plate along the section A-A of FIG. 8a,

FIG. 9a shows a simplified cross-sectional view of a cleaning device in accordance with an eighth embodiment,

FIG. 9b shows a simplified perspective view of the cleaning device of FIG. 9a,

FIG. 10 shows a simplified cross-sectional view of a cleaning device in accordance with a ninth embodiment,

FIGS. 11a-11c shows representations of a further possible shaping of a housing of the cleaning device in accordance with FIG. 19 and its positioning or arrangement, as the case may be, in space,

FIG. 12a-12d shows in each case, schematically simplified views of a hydraulic line, in which cleaning devices are incorporated or integrated, as the case may be,

FIG. 13 shows a schematically simplified view of a hydraulic circuit, in which cleaning devices are incorporated or integrated, as the case may be, and

FIG. 14 shows a schematically simplified cross-sectional view of a cleaning body, which is part of a cleaning device.

### DETAILED DESCRIPTION

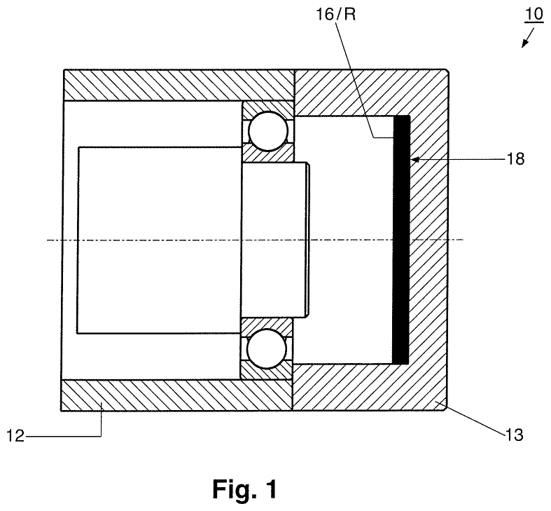

With reference to FIGS. 1-14, preferred embodiments of a cleaning device 10, including associated components and possible arrangements thereof, are shown and explained below, with which a liquid, in particular in the form of an oil-based liquid or a hydraulic oil, can be cleaned of dirt particles effectively and by simple means. Identical features in the drawing are in each case marked with the same reference signs. At this point, it is separately pointed out that the drawing is only simplified and in particular shown without scale.

In all of the embodiments still to be described below, the cleaning device 10 comprises a housing 12, which can have various shapes. In any case, the housing contains a liquid for which the present invention is intended to achieve cleaning with respect to dirt particles or the like.

For the following description of the invention, the liquid is always referred to as “oil-based liquid,” without this being understood as limiting.

FIGS. 1-7 show a cleaning device 10 in accordance with a first to seventh embodiment. Such embodiments have in common that the cleaning device 10 comprises a housing 12 to which a cover 13 is attached at the side. A cleaning body 16 is attached in or adjacent to the cover 13. FIGS. 1-6 in each case show a simplified cross-section through the housing 12 along its longitudinal direction. These embodiments are now explained in detail as follows:

FIG. 1 shows a simplified cross-sectional view of the first embodiment of the cleaning device 10.

A shaft that is not more specifically designated can be mounted in the housing 12 by means of a bearing device.

A cover 13 is fastened to the housing 12 adjacent to the said bearing device. Such cover 13 is designed to be cup-shaped and thus has an inner face 18.

The cleaning device 10 comprises at least one cleaning body 16, which is accommodated within the housing 12. Such cleaning body 16 can be supplied with the oil-based liquid—specifically, this can mean that the oil-based liquid flows past the cleaning body 16 within the housing 12 if the cover 13 is mounted or fastened, as the case may be, to it.

With the first embodiment of the cleaning device 10, the cleaning body 16 is fastened to the front-side inner surface 18 of the cover 13. If the cover 13—as shown in the representation of FIG. 1—is fastened to the housing 12, the cleaning body 16 is therefore located in the interior space of the housing 12 and can come into contact with the oil-based liquid contained therein or be supplied with it, as the case may be.

The cleaning body 16 is expediently designed as a cleaning mat with a fibrous texture. Preferably, with the first embodiment, the surface shape of the cleaning mat, which is also designated “R” here, is adapted to the front-side inner surface 18 of the cover 13. In other words, the inner surface 18 of the cover 13 is completely covered by the cleaning mat R.

FIG. 14 illustrates a cross-sectional view of a possible design of the cleaning body 16, which can be designed as a cleaning mat R as explained. In any case, a top layer 16.2 and a bottom layer 16.3 are provided for such a cleaning body 16 (or the cleaning mat R, as the case may be), wherein such layers in each case contain fiber material F. In this connection, it is advantageous for the present invention that the density of the bottom layer 16.3 is greater than the density of the top layer 16.2. With such an embodiment of the cleaning body 16 or the cleaning mat R, as the case may be, it can be provided that the bottom layer 16.3 contains a loop-shaped fiber material F, whereas the top layer 16.2 contains only individual fibers 17, which are directed at an outer free edge of the top layer 16.2 with their respective free ends away from the bottom layer 16.3 and outwards.

The configuration of the cleaning body 16 described above (or the cleaning mat R, as the case may be) ensures that there is an open surface on an outer edge of the top layer 16.2, which makes it possible for dirt particles to enter or penetrate, as the case may be. In contrast, the comparatively greater density of the bottom layer 16.3 has the effect that dirt particles, once they have entered the top layer 16.2 and “migrated” in the direction of the bottom layer 16.3, then remain in the bottom layer 16.3 and are permanently retained there.

If the oil-based liquid located in the interior space of the housing 12 comes into contact with the cleaning mat R or supplies it, as the case may be, the fibrous texture of such cleaning mat R ensures that dirt particles contained in the oil-based liquid—as just explained—can penetrate into the top layer 16.2 of the cleaning mat R and subsequently, if they have moved further in the direction of the bottom layer 16.3 within the cleaning mat R, are held there by the bottom layer 16.3. As already explained elsewhere above, the dirt particles are retained or remain, as the case may be, within the cleaning mat R or its bottom layer 16.3, as the case may be, due to the fact that the velocity of the oil-based liquid there is zero. In concrete terms, this means that once dirt particles have entered the cleaning mat R and reached the bottom layer 16.3, they remain there “forever.”

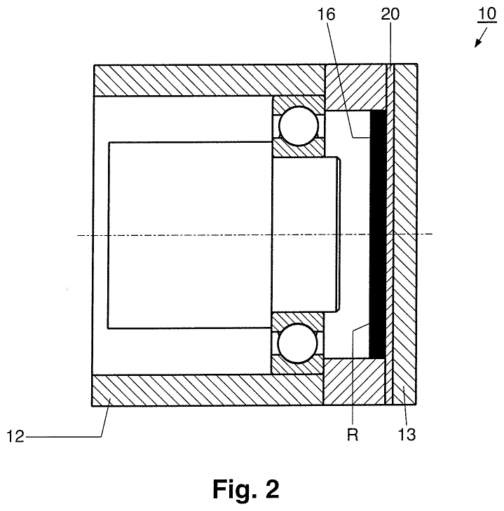

FIG. 2 shows the cleaning device 10 in accordance with a second embodiment. The housing 12 as such is designed in the same manner as in the first embodiment. The same applies to the configuration of the cleaning mat R, such that, in order to avoid repetition, reference may be made to the explanations of the first embodiment.

The second embodiment differs from the first embodiment only in the manner in which the cleaning mat R is fastened. Specifically, the cleaning mat is fastened here on or to, as the case may be, a carrier plate 20. The cleaning mat R is then positioned within the housing 12 in such a manner that the carrier plate 20 is fastened to the housing 12 via a two-part cover 13 and the cleaning mat R is turned towards the interior space of the housing 12.

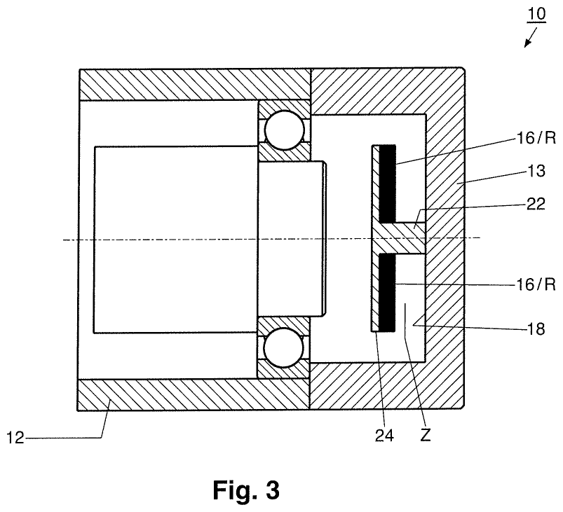

With the third embodiment of the cleaning device 10, as shown by the representation in FIG. 3, a carrier structure 22 is fastened to the front-side inner surface 18 of the cover 13, to which a flat holding element 24 is connected. In the simplest case, the holding element 24 and the carrier structure 22 are formed in one piece. In any case, the flat holding element 22 is connected to the carrier structure 22 in such a manner that its surface extension runs parallel to the front-side inner surface 18 of the cover 13.

With the third embodiment, the cleaning body 16 in the form of a cleaning mat R is attached to only one side of the holding element 24, specifically to the side directly opposite the front-side inner surface 18 of the cover 13. This ensures that the open surface of the top layer 16.2 (see FIG. 14) of the cleaning mat R is only turned towards the inner surface 18 and thus points away from moving parts that may be contained in the interior space of the housing 12. As a result, the oil-based liquid only flows past the cleaning mat R in the intermediate space Z, which is bounded on the one hand by the holding element 24 and on the other hand by the front-side inner surface 18 of the cover 13. Thereby, the dimensions or diameter, as the case may be, of the holding element 24 are sufficiently small compared to the inside diameter of the cover 13, such that the oil-based liquid can flow behind the holding element 24 and thus enter the intermediate space Z, in order to subsequently flow past the cleaning mat R at a sufficiently low velocity.

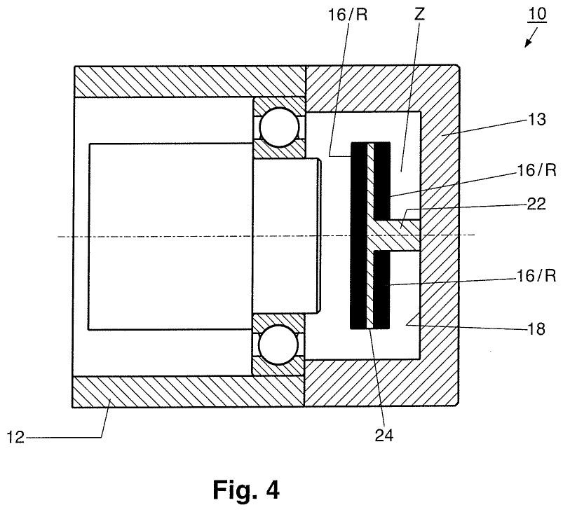

The fourth embodiment of the cleaning device 10 in accordance with FIG. 4 substantially corresponds to the third embodiment, with the only difference that the cleaning mat R is now attached to both sides of the holding element 24.

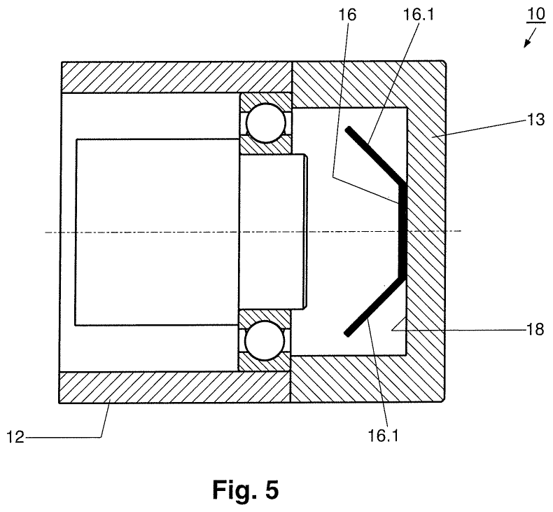

With the fifth embodiment of the cleaning device 10 in accordance with FIG. 5, it is provided that a central region of the cleaning body 16 is fastened to the front-side inner surface 18 of the cover 13, wherein an edge-side section 16.1 of the cleaning body 16 projects from the inner surface 18 of the cover. Thereby, it should be understood that the cleaning body 16 can also be designed in the form of a cleaning mat R (see FIG. 14). To avoid repetition, reference may be made to the above explanations on the nature of such a cleaning mat R.

With respect to the fifth embodiment, it should be pointed out that the projecting section 16.1 of the cleaning body 16 (or the cleaning mat R, as the case may be) interacts with the adjacent wall sections of the cover 13 to create chambers into which the oil-based liquid can enter or flow, as the case may be. Thereby, the cleaning mat R is designed in such a manner that its fibers F are aligned vertically away from the surface on all sides, at least in the region of the projecting section 16.1, as shown in FIG. 14 for the top layer 16.2 and its individual fibers 17.

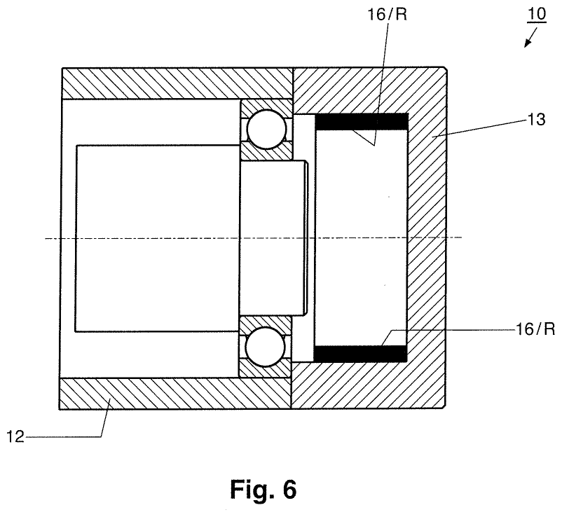

With the sixth embodiment of the cleaning device 10 in accordance with FIG. 6, it is provided that the cleaning mat R is attached to the inner circumferential surface of the cup-shaped cover 13. Thereby, it is expedient for the cleaning mat R to completely cover the inner circumferential surface of the cover 13, such that the cleaning mat R has the largest possible effective surface area with which the oil-based liquid can interact as it flows past.

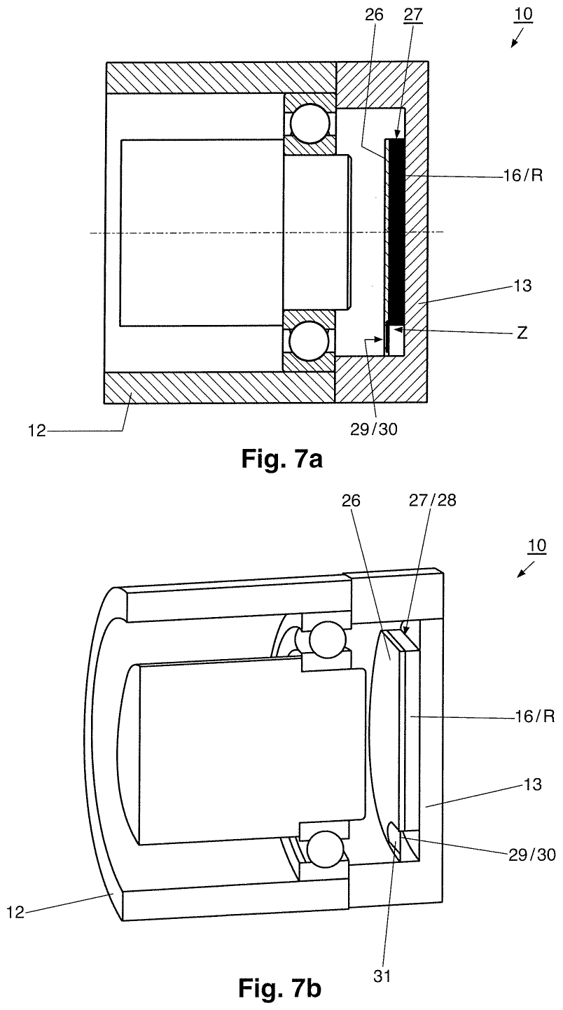

A seventh embodiment of the cleaning device 10 is shown in FIG. 7a and FIG. 7b. FIG. 7a shows a simplified cross-section through the housing 12 along its longitudinal direction, wherein FIG. 7b shows a perspective view of such cross-section in each case.

With the seventh embodiment of the cleaning device 10 in accordance with FIG. 7a or FIG. 7b, as the case may be, it is provided that at least one plate 26 is attached to the inner circumferential surface of the cover 13, in particular in the form of a circular disk, which is arranged in a manner parallel to the front-side inner surface 18 of the cover 13 and at a distance therefrom. The cleaning body 16, preferably in the form of a cleaning mat R (see FIG. 14), is attached to a rear side of the plate 26 turned towards the front-side inner surface of the cover. An inlet opening 27 is provided for the plate 26 at or in its upper region. In the same manner, an outlet opening 29 (see FIG. 7a) for the liquid is provided on or in the lower region of the plate 26 thereof.

The distance between the plate 26 and the front-side inner surface 18 of the cover 13 is selected such that an intermediate space Z is formed between the plate 26 and the inner surface 18. The cleaning mat R is thus attached to the rear side of the plate 26 in such a manner that it is accommodated in such intermediate space Z.

A cleaning mat R can be attached to the rear side of the plate 26 in such a manner that the fibers 17, which are directed outwards from the top layer 16.2 of the cleaning mat R at an outer edge, reach so far towards the inner surface 18 of the cover that they touch such inner surface 18.

With the seventh embodiment specified above, the inlet opening 27 is formed by a flattening of the plate 26. This makes it possible for oil-based liquid to flow through the inlet opening 27 and enter the intermediate space Z in this manner in order to flow past the cleaning mat R in a downward direction.

The outlet opening 29 is formed by a recess 30, which is formed in the disk-shaped plate 26. As a result, it is possible for oil-based liquid to flow from the intermediate space Z bounded between the rear side of the plate 26 and the front-side inner surface 18 of the cover 13 through the recess 30 back into an interior space of the housing 12, which is adjacent to the front side of the plate 26.

In order to prevent individual fibers 17, which may have become detached from the upper layer 16.2 of the cleaning mat R, from entering the interior space of the housing 12 through the outlet opening 29, the seventh embodiment can provide for a fine-mesh grid element 31 to be accommodated in the recess 30. With the aid of such a grid element 31, individual fibers 17 can be prevented from passing through the outlet opening 29.

The fixing of the grid element 31 in the region of the outlet opening 29 can be achieved in a simple manner for the seventh embodiment of the cleaning device 10 in that two plates 26 are attached to the inner circumferential surface of the cover 13 parallel to one another, which are arranged in a manner parallel to the front-side inner surface 18 of the cover 13 and at a distance therefrom. The fine-mesh grid element 31 is then arranged between such two plates 26 and is thus held in the respective recesses 30 of the plates 26.

During operation of a cleaning device 10 in accordance with the seventh embodiment in accordance with FIG. 7a, the oil-based liquid is cleaned as follows: Countless oil droplets form in the interior space of the housing 12 around the bearing element contained therein, which is arranged in a manner adjacent to the front side of the plate 26. A part of such oil droplets then regularly and repeatedly enter the intermediate space Z through the inlet opening 27, i.e. into the region between the rear side of the plate 26 and the front-side inner surface 18 of the cover 13, where the cleaning mat R is located. As a result of gravity, the oil droplets, after they have entered the said intermediate space Z through the inlet opening 27, can only move downwards, thereby slowly flowing past the countless fibers 17, which are located on the outer side of the upper layer 16.2 of the cleaning mat R. The fiber structure of the cleaning mat R ensures that the oil droplets are repeatedly guided through the fibers 17 to the base of the cleaning mat, i.e. into its bottom layer 16.3. This ensures that dirt particles that are contained in the oil droplets of the oil-based liquid are continuously bound to the fibers or in the bottom layer 16.3, as the case may be, of the cleaning mat R over time.

The cleaned oil can then flow back into the interior space of the housing 12 in the lower region of the intermediate space Z through the grid element 31, which is accommodated in the recess 30, as explained.

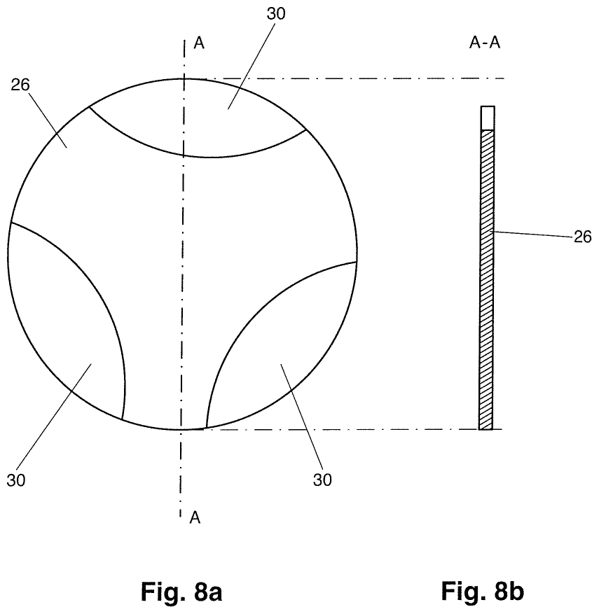

FIG. 8a shows a top view of a plate 26, which can be used in a modification or simplification, as the case may be, of the seventh embodiment of the cleaning device 10. A cleaning mat R can be attached to one side of the plate 26 in accordance with FIG. 8a in the same manner as explained in connection with FIG. 7a.

The plate 26 in accordance with FIG. 8a represents a simplification in that at least three recesses 30 are formed along its outer circumference. Such recesses 30 have the same distance relative to one another in each case and are therefore evenly distributed along the outer circumference of the plate 26. As an alternative to the illustrations shown in FIG. 8a with three recesses 30, it can also be provided that five recesses 30 are formed along the outer circumference of the plate 26. A circular shape for the plate 26 is not required here, such that the plate 26 can also have a geometry that deviates from the circular shape with respect to its outer circumference.

In any case, for the modification specified above for the plate 26 in accordance with FIG. 8a—in view of the odd number of recesses 30 (as shown: three recesses 30; or alternatively, not shown: five recesses 30 are also possible)—it is ensured that there is an entry and exit of oil-based liquid into or out of, as the case may be, the intermediate space Z at the top and bottom of the plate 26 respectively, specifically irrespective of a specific positioning of the plate 26. In this respect, this simplifies the assembly of the plate 26, because there is always an “up” and a “down” in view of the odd number of recesses. Thereby, for further simplification, the fine-mesh grid element 31 (see FIG. 7b) can be omitted.

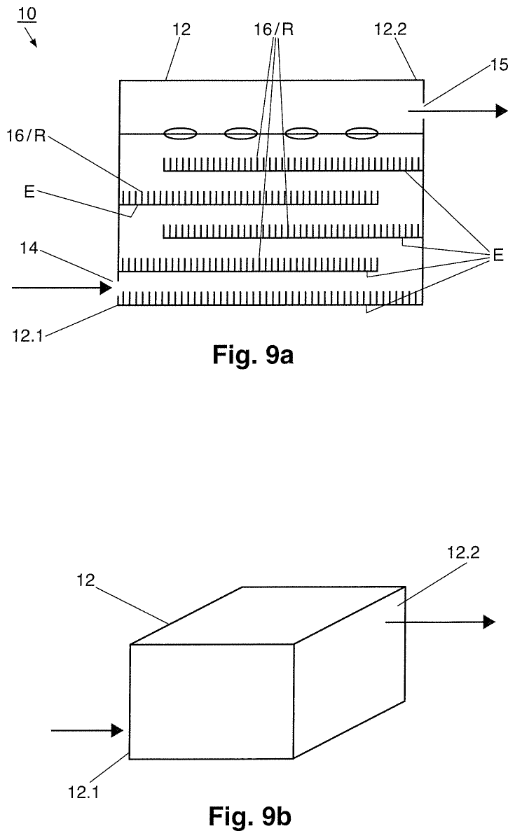

FIG. 9a and FIG. 9b show an eighth embodiment of the cleaning device 10, specifically both in a cross-sectional view (FIG. 9a) and in a perspective view from the outside (FIG. 9b). With such eighth embodiment, the cleaning device 10 comprises a housing 12 with an inlet opening 14 and an outlet opening 15 for the oil-based liquid.

Specifically, with the eighth embodiment, the inlet opening 14 for the oil-based liquid is provided in a lower region 12.1 of the housing 12, for example on a right side thereof, wherein the outlet opening 15 is provided on an opposite side of the housing 12 in an upper region 12.2 thereof, for example on a left side thereof. This arrangement of both the inlet opening 14 and the outlet opening 15 ensures that the oil-based liquid, after it has entered the interior space of the housing 12 through the inlet opening 14, must flow diagonally upwards through the housing 12 in order to reach the outlet opening 15.

With the eighth embodiment, as shown in the representation of FIG. 9a, a plurality of levels E are provided or inserted, as the case may be, within the housing 12. With regard to optimum space utilization within the housing 12, it is advantageous that such levels—viewed in the vertical direction—can be arranged one above the other and parallel to one another in each case. Adjacent to the side walls of the housing, such levels E in each case have a recess or an opening, as the case may be, alternating at a front end or rear end thereof, as the case may be, through which the oil-based liquid can continue to flow in an upwards direction if it has reached the end of a respective level E.

In each case, a cleaning body 16, preferably in the form of a large-area cleaning mat R, is attached to the upper side of each of the individual horizontal levels E.

During operation of a cleaning device 10 in accordance with the eighth embodiment, the oil-based liquid is cleaned in such a manner that it is initially introduced into the housing 12 through the inlet opening 14. The oil-based liquid then flows over the individual levels E and thereby—viewed in a vertical direction—in a meandering upward direction through the housing 12 until it exits the housing 12 again through the outlet opening 15.

The design of the housing 12 with the eighth embodiment and the individual levels E has the advantage that a very large effective surface area is achieved for the cleaning mats R, which are attached to the respective upper sides of the individual levels E. Thereby, the further advantage is that the meandering course of the flow of the oil-based liquid upwards through the housing 12 reduces the flow velocity of the oil-based liquid, thereby calming the flow for the oil-based liquid. In addition to the large effective surface area of the cleaning mats R, this also increases the likelihood that dirt particles contained in the oil-based liquid will sink or become entangled, as the case may be, in the fiber structure of the cleaning mats R when they flow past the cleaning mats R and then remain there permanently, as explained.

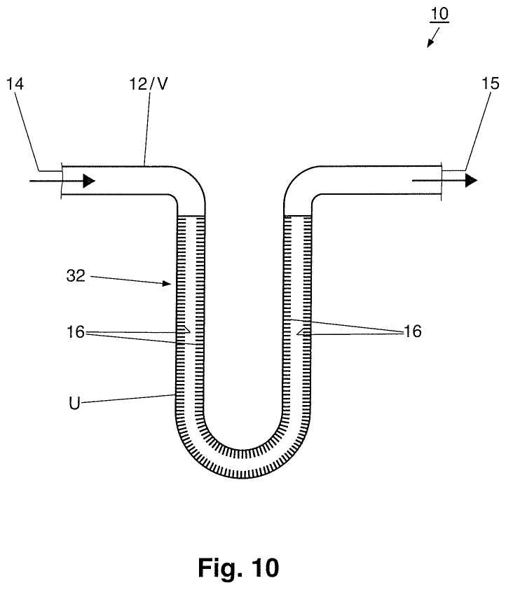

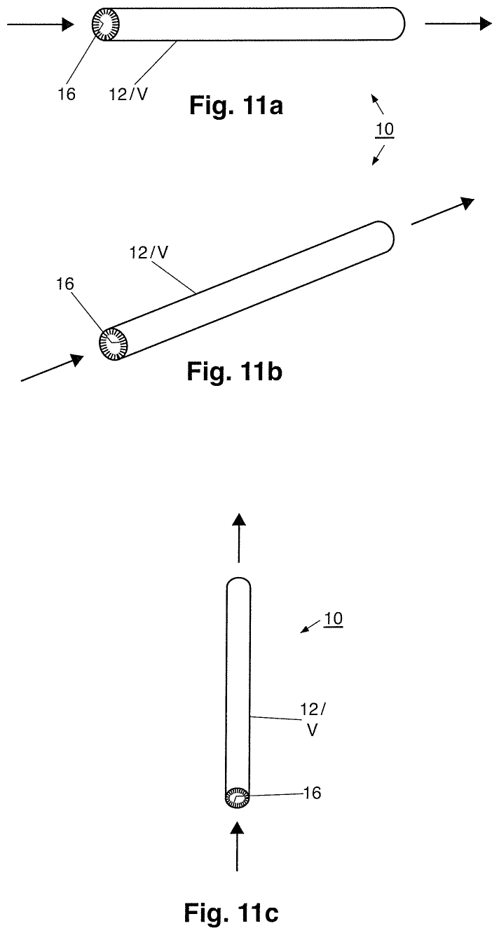

FIG. 10 and FIG. 11 show a ninth embodiment of the cleaning device 10, with which the housing 12 is designed in the form of a connecting line V. Regardless of the specific shaping of such connecting line V, it should be understood that a cleaning body 16, preferably with a fibrous structure, is attached to or formed on, as the case may be, an inner circumferential surface of such connecting line V. Furthermore, it is expedient that the cleaning body 16 is provided within the connecting line V along its entire longitudinal extension.

With the embodiment of FIG. 10, the connecting line V has a U-shaped section 32, wherein the cleaning body 16 is provided on the inner circumferential surface along such section 32.

The connecting line is provided with an inlet opening 14 and an outlet opening 15 for the entry and exit of oil-based liquid, such that the flowing through of the connecting line V with oil-based liquid can be ensured.

In the representations in FIG. 11, the connecting line V has a straight course in each case. The individual representations in FIG. 11 differ in that the connecting line V can be arranged horizontally (see FIG. 11a), at an angle (see FIG. 11b) or vertically (see FIG. 11c) in space.

With respect to the ninth embodiment specified above of the cleaning device 10, it is emphasized that its housing 12 or connecting line V, as the case may be, can be produced with any cross-section and in particular from plastic.

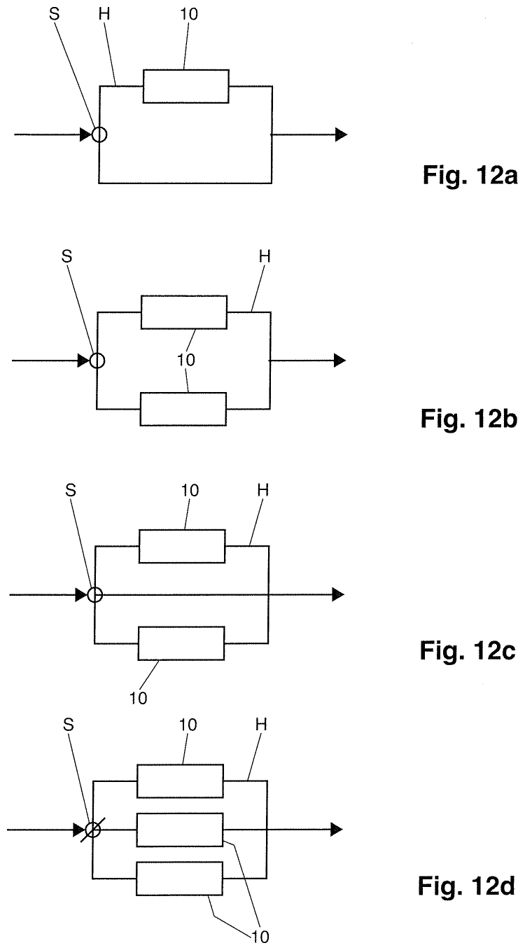

The individual representations in FIGS. 12a-12d show various configurations for a hydraulic line H, in which at least one cleaning device 10 is incorporated or integrated, as the case may be, in accordance with the embodiments specified above. Thereby, the direction of flow for the oil-based liquid is indicated by arrows in each case. With all of such possible configurations in accordance with FIGS. 12a-12d, a switching valve S can be provided upstream of a cleaning device 10 (or the cleaning devices 10, as the case may be), with which the oil-based liquid can be guided through at least one specific branch of the hydraulic line H. With the aid of the switching valve S, it is also possible for a certain branch of the hydraulic line H to temporarily stop the flow of oil-based liquid, such that the oil-based liquid that is already in such then “shut-down” branch can calm down. This promotes sedimentation of dirt particles in a downward direction into the fiber structure of the cleaning mat R.

With respect to the individual configurations for a hydraulic line H in accordance with FIGS. 12a-12d, it should be specifically pointed out at this point that, in accordance with a further embodiment of the cleaning device 10, these can also be combined in one housing, specifically in any combination of the configurations according to FIGS. 12a-12d.

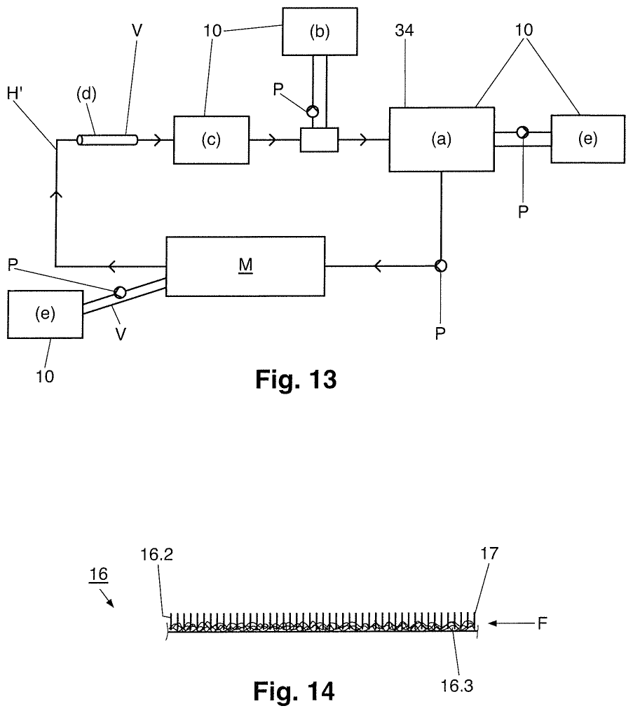

FIG. 13 shows a simplified hydraulic circuit H′ for a machine M, in which an oil-based liquid is circulated as indicated by the arrow directions shown in each case.

The hydraulic circuit H′ comprises a reservoir for the oil-based liquid, which is designated as “34” in FIG. 13.

One or more cleaning devices 10 can be incorporated or integrated, as the case may be, into the hydraulic circuit H′ in accordance with the embodiments specified above. This is explained by the following letter nomenclature:
(a): The reservoir 34 for the oil-based liquid can be replaced by a cleaning device 10.
(b): A cleaning device 10 can be connected to the hydraulic circuit H′ in the bypass flow, preferably with its own pump P.
(c): Upstream of the reservoir 34, a cleaning device 10 is integrated into the circuit.
(d): A cleaning device in accordance with the ninth embodiment (see FIG. 10, FIG. 11) is integrated into the line of the hydraulic circuit.
(e): A cleaning device 10 is directly connected to the oil reservoir of the machine M and/or to the reservoir 34, preferably with its own pump P.

With respect to the options specified above in accordance with letters (a)-(e), according to which the integration of a cleaning device 10 into a hydraulic circuit H′ is possible, it is understood that such variants in accordance with letters (a) to (e) can also be combined in any form.

At this point it should be specifically pointed out that with the cleaning device or mat, as the case may be, degassing of the liquid is also possible in that gas or air bubbles contained in the liquid also adhere to the associated fiber material of the cleaning mat.

Finally, for all of the embodiments specified above of the present invention, it should be pointed out once again that the following aspects are of importance for the operation of the cleaning body 16 or the cleaning mat R, as the case may be:
Sedimentation as a result of gravity;
Deceleration (i.e., reduction of the flow velocity) of the oil-based liquid and the dirt particles it contains in the vicinity of the fiber material F to zero;
Increase in the density of the fiber material F starting from the top layer 16.2 in the direction of the bottom layer 16.3 of the cleaning mat R; and
Adhesion of dirt particles to the fiber material F, in particular in the region of the bottom layer 16.3 of the cleaning mat R, through “mechanical entanglement” and possibly also by attraction effects in the microscopic range.

### LIST OF REFERENCE SIGNS

10 Cleaning device
12 Housing
12.1 Lower region (of the housing 12)
12.2 Upper region (of housing 12)
13 Cover
14 Inlet opening
15 Outlet opening
16 Cleaning body
16.1 Section (of the cleaning body 16)
16.2 Top layer
16.3 Bottom layer
17 Fiber(s)
18 Front-side inner surface of the cover
20 Carrier plate
22 Carrier structure
24 Flat holding element
26 Plate
27 Inlet opening
28 Flattening
29 Outlet opening
30 Recess
31 Fine-mesh grid element
32 U-shaped section (of connecting line V)
34 Reservoir
E Level(s)
F Fiber material
H Hydraulic line
H′ Hydraulic circuit
M Machine
P Pump
R Cleaning mat
S Switching valve
V Connecting line
Z Intermediate space

1.-28. (canceled)

29. A cleaning device (10) for liquids, comprising:
a housing (12), which contains a liquid or through which a liquid flows; and
a cleaning body (16), which is accommodated within the housing (12) and to which the liquid can be supplied,
wherein a material of the cleaning body (16) is designed such that impurities contained in the liquid can be introduced and absorbed therein,
wherein the cleaning body (16) is attached in a cover (13) of the housing (12) or adjacent thereto,
wherein the cleaning body (16) comprises fiber material (F),
wherein the cleaning body (16) comprises a top layer (16.2) and a bottom layer (16.3),
wherein the top layer (16.2) contains fibers (17), which at an outer free edge of the top layer (16.2) are outwardly directed with their respective free ends away from the bottom layer (16.3) whereby the top layer (16.2) of the cleaning body (16) has an open surface on an outer edge into which contaminants and/or dirt particles can be introduced,
wherein a density of the bottom layer (16.3) is greater than a density of the top layer (16.2),
wherein the cleaning body (16) is attached to the housing (12) or a part thereof with the bottom layer (16.3), and
wherein the top layer (16.2) can be supplied with the liquid.

30. The cleaning device (10) according to claim 29,
wherein the cleaning body (16) is attached at least to a front-side inner surface (18) of the cover (13).

31. The cleaning device (10) according to claim 30,
wherein the cleaning body (16) completely covers the front-side inner surface (18) of the cover (13).

32. The cleaning device (10) according to claim 30,
wherein the cleaning body (16) has a section (16.1) that, at at least one point, projects from the front-side inner surface (18) of the cover (13).

33. The cleaning device (10) according to claim 29,
wherein the cleaning body (16) is attached to a carrier plate (20),
wherein the carrier plate (20) can be fastened to the housing (12) by the cover (13) or can be fastened adjacent to the housing (12) by a two-part cover (13).

34. The cleaning device (10) according to claim 30,
wherein a carrier structure (22) with a flat holding element (24) is attached to the front-side inner surface (18) of the cover (13),
wherein the cleaning body (16) is attached to a rear side of the flat holding element (24) turned towards the front-side inner surface (18) of the cover (13), and
wherein a further cleaning body (16) is fastened to an opposite surface of the flat holding element (24).

35. The cleaning device (10) according to claim 34,
wherein the flat holding element (24) is attached to the carrier structure (22) in such a manner that its surfaces are arranged parallel to the front-side inner surface (18) of the cover (13).

36. The cleaning device (10) according to claim 30,
wherein at least one plate (26) is attached to an inner circumferential surface of the cover (13),
wherein the plate (26) is arranged parallel to the front-side inner surface (18) of the cover (13) and at a distance therefrom,
wherein the cleaning body (16) is attached to a rear side of the plate (26) turned towards the front-side inner surface (18) of the cover (13), and
wherein an inlet opening (27) is provided for the plate (26) at or in an upper region thereof and an outlet opening (29) for the liquid is provided at or in a lower region thereof.

37. The cleaning device (10) according to claim 36,
wherein the inlet opening (27) is formed by a flattening of the plate (26), such that the liquid can enter past the flattening from above into an intermediate space (Z), which is bounded by the rear side of the plate (26) and by the front-side inner surface (18) of the cover (13).

38. The cleaning device (10) according to claim 37,
wherein the outlet opening (29) is formed by a recess (30) which is formed in the plate (26), such that liquid can flow from the intermediate space (Z) bounded between the rear side of the plate (26) and the front-side inner surface (18) of the cover (13) through the recess (30) back into an interior space of the housing (12), against which a front side of the plate (26) is adjacent.

39. The cleaning device (10) according to claim 38,
wherein a fine-mesh grid element (31) is accommodated in the recess (30), which prevents individual fibers (17) from passing through.

40. The cleaning device (10) according to claim 39,
wherein two plates (26) are attached to the inner circumferential surface of the cover (13) parallel to one another,
wherein the two plates are arranged parallel to the front-side inner surface (18) of the cover (13) and at a distance therefrom,
wherein the fine-mesh grid element (31) is arranged between the two plates (26) and thereby is held in or adjacent to the respective recesses (30) of the plates (26).

41. The cleaning device (10) according to claim 36,
wherein at least three recesses (30) are formed along an outer circumference of the plate (26), and
wherein the at least three recesses (30) are spaced evenly apart from one another.

42. The cleaning device (10) according to claim 29,
wherein the cleaning body (16) is attached to an inner circumferential surface of the cover (13), and
wherein the cleaning body (16) completely covers the inner circumferential surface of the cover (13).

43. A cleaning device (10) for liquids, comprising:
a housing (12) with an inlet opening (14) and an outlet opening (15) for a liquid, wherein the liquid can flow through the housing (12) from the inlet opening (14) to the outlet opening (15); and
at least one cleaning body (16), which is accommodated within the housing (12) and to which the liquid can be supplied,
wherein a plurality of levels (E) are provided in the housing (12),
wherein a cleaning body (16) is attached on at least one side of each of the levels (E),
wherein a material of the cleaning body (16) is designed such that impurities contained in the liquid can be introduced and absorbed therein,
wherein the inlet opening (14) is formed on one side of the housing (12) in a lower region (12.1) thereof, and the outlet opening (15) is formed on an opposite side of the housing (12) in an upper region (12.2) thereof, and
wherein the levels (E) in the housing (12) are arranged next to one another in such a manner that the liquid can flow through the housing (12) from the inlet opening (14) to the outlet opening (15) in a meandering pattern, and
wherein the levels (E) in the housing (12) are arranged, viewed in a vertical direction, in each case one above another whereby the liquid can flow through the housing (12), viewed in a vertical direction, from the inlet opening (14) in the direction of the outlet opening (15) in a meandering pattern.

44. The cleaning device (10) according to claim 43,
wherein the inlet opening (14) is provided in the housing (12) on a left or right side, and
wherein the outlet opening (15) is provided in the housing (12) on an opposite side of the housing (12).

45. The cleaning device (10) according to claim 43,
wherein the levels (E) in the housing (12) are each arranged horizontally and parallel to one another.

46. A cleaning device (10) for liquids, comprising:
a housing (12) with an inlet opening (14) and an outlet opening (15) for a liquid, wherein the liquid can flow through the housing (12) from the inlet opening (14) to the outlet opening (15); and
a cleaning body (16), which is accommodated within the housing (12) and to which the liquid can be supplied, wherein a material of the cleaning body (16) is designed such that impurities contained in the liquid can be introduced and absorbed therein,
wherein the housing (12) is designed in form of a connecting line (V),
wherein the cleaning body (16) is attached within the connecting line (V) on an inner circumferential surface thereof, and
wherein the cleaning body (16) comprises a fiber material (F).

47. The cleaning device (10) according to claim 46,
wherein the cleaning body (16) is attached within the connecting line (V) along its entire longitudinal extension and/or over its entire inner circumferential surface.

48. The cleaning device (10) according to claim 46,
wherein the connecting line (V) has a U-shaped section (32), and
wherein the cleaning body (16) is provided within the connecting line (V) along its U-shaped section (32).

49. The cleaning device (10) according to claim 46,
wherein the connecting line (V) is a flexible hose made of plastic.

50. The cleaning device (10) according to claim 46,
wherein the cleaning body (16) consists of porous material or comprises porous material.

51. The cleaning device (10) according to claim 46,
wherein the cleaning body (16) is a cleaning mat (R) with a fibrous structure.

52. The cleaning device (10) according to claim 43,
wherein the cleaning body (16) has a top layer (16.2) and a bottom layer (16.3),
wherein a density of the bottom layer (16.3) is greater than a density of the top layer (16.2),
wherein the cleaning body (16) is attached with its bottom layer (16.3) to the housing (12) or a part thereof, and
wherein the top layer (16.2) of the cleaning body (16) can be supplied with the liquid.

53. The cleaning device (10) according to claim 52,
wherein the top layer (16.2) contains fibers (17) that are outwardly aligned at an outer free edge of the top layer (16.2) with their respective free ends directed away from the bottom layer (16.3), such that the top layer (16.2) of the cleaning body (16) has an open surface at its outer edge, into which impurities and/or dirt particles can be introduced.

54. The cleaning device (10) according to claim 53,
wherein the cleaning body (16) is attached to a surface of a holding element (24) or a plate (26) in such a manner that the fibers (17) of the cleaning body (16) are turned towards a front-side inner surface (18) of a cover (13), such that the fibers (17) contained in the top layer (16.3) of the cleaning body (26) touch the front-side inner surface (18) of the cover (13) with their outer free ends.

55. A hydraulic line (H) through which an oil-based liquid or hydraulic oil can flow,
wherein at least one cleaning device (10) according to claim 29 is incorporated or integrated in the hydraulic line (H).

56. A hydraulic line (H) through which an oil-based liquid or hydraulic oil can flow,
wherein at least two cleaning devices (10) according to claim 29 are incorporated into the hydraulic line (H),
wherein the at least two cleaning devices (10) are connected in parallel with one another.

57. The hydraulic line (H) according to claim 56,
wherein a switching valve (S) is arranged upstream of the cleaning devices (10), by which a flow of the liquid into at least one branch of the hydraulic line (H) can be switched.

58. A hydraulic circuit (H′) for a machine (M), in which an oil-based liquid or hydraulic oil is circulated,
wherein at least one cleaning device (10) according to claim 29 is incorporated or integrated into the hydraulic circuit (H).
